(19) United States
(12) Patent Application Publication
(10) Pub. No.: US 2026/0065039 A1
(43) Pub. Date: Mar. 5, 2026

(54) SPIKE NEURAL NETWORK CIRCUIT, STDP LEARNING CIRCUIT, AND OPERATION METHOD OF STDP LEARNING CIRCUIT

(71) Applicant: ELECTRONICS AND TELECOMMUNICATIONS RESEARCH INSTITUTE, Daejeon (KR)

(72) Inventors: Kwang IL OH, Daejeon (KR); Byung-Do YANG, Daejeon (KR); Tae Wook KANG, Daejeon (KR); Min-Woo KIM, Cheongju-si (KR); Hyuk KIM, Daejeon (KR); Jae-Jin LEE, Daejeon (KR)

(21) Appl. No.: 19/308,587

(22) Filed: Aug. 25, 2025

(30) Foreign Application Priority Data
Sep. 2, 2024 (KR) 10-2024-0118729
Jul. 29, 2025 (KR) 10-2025-0103375

(51) Int. Cl. G06N 3/049; G06N 3/065; G06N 3/08

(52) U.S. Cl. CPC G06N 3/049; G06N 3/065; G06N 3/08

(57) ABSTRACT

A spiking neural network (SNN) circuit performs Spike-Timing Dependent Plasticity (STDP) learning. A synapse array, with a plurality of synapse circuits, accumulates charge on corresponding column lines based on weight values in response to input spikes. A neuron array generates output spikes when accumulated charge exceeds a threshold potential. The circuit includes a timer and registers to record the occurrence times of both input and output spikes. A time difference calculator determines the temporal difference between these spikes. A weight update circuit then modifies the weight values of the synapse circuits based on this calculated time difference, enabling the SNN to update weights and learn efficiently.

### CROSS-REFERENCE TO RELATED APPLICATIONS

This application claims priority under 35 U.S.C. § 119 to Korean Patent Application No. 10-2024-0118729 filed on Sep. 2, 2024, and Korean Patent Application No. 10-2025-0103375 filed on Jul. 29, 2025, in the Korean Intellectual Property Office, the disclosures of which are incorporated by reference herein in their entireties.

### BACKGROUND

### 1. Field of the Invention

The present disclosure relates to a neural network, and more particularly, to a spike neural network circuit, a spike-timing dependent plasticity (STDP) learning circuit, and an operation method of the STDP learning circuit.

### 2. Description of Related Art

A Spike Neural Network (SNN) is one of the methods for implementing an artificial intelligence network that transfers an input as a spike in the form of a pulse with a short duration for computation. Unlike conventional perceptron or convolution-based networks that transfer signals with numerical values, an SNN receives an intermittent or periodic spike train as an input (via an axon), and synapses and neurons perform computations.

The synapse applies a synapse weight to the input spike and transmits it to the neuron, and the neuron accumulates input results from multiple synapses to form a membrane potential and then fires and outputs a spike when the potential exceeds a reference potential.

A synapse weight indicating a connection strength may be updated according to a difference between an input and an output spike occurrence time, and this is implemented by an STDP learning method. However, it is difficult to directly implement STDP learning by a semiconductor circuit, and synapse weights learned mainly by software have been applied and operated.

### SUMMARY

An object of the present disclosure is to provide a spike neural network circuit that autonomously performs STDP learning.

A spike neural network circuit according to an embodiment of the present disclosure may comprise a synapse array including a plurality of row lines, a plurality of column lines, and a plurality of synapse circuits connected to the plurality of row lines and the plurality of column lines and configured to perform a charge accumulation operation on a corresponding column line based on a weight value in response to an input spike signal received through the corresponding row line, a neuron array including a plurality of neuron circuits configured to generate an output spike signal based on a result of the charge accumulation operation and a threshold potential, wherein the plurality of neuron circuits are connected to one end of the plurality of column lines, a timer configured to output a time value that increases over time, an input register array corresponding to each of the plurality of row lines and including a plurality of input time registers configured to store the time value that the timer outputs when the input spike signal occurs on the corresponding row line, an output register array corresponding to each of the plurality of column lines and including a plurality of output time registers configured to store the time value that the timer outputs when the output spike signal occurs on the corresponding column line, a time difference calculator configured to calculate an occurrence time difference between occurrence of the output spike signal and occurrence of the input spike signal, and a weight update circuit configured to update, in response to one of the input spike signal or the output spike signal, the weight value of the plurality of synapse circuits based on a weight change amount corresponding to the occurrence time difference.

An STDP learning circuit according to an embodiment of the present disclosure may comprise a timer configured to output a time value that increases over time, a plurality of input time registers corresponding to each of a plurality of row lines of a synapse array and configured to store the time value that the timer outputs when an input spike signal occurs on the corresponding row line, a plurality of output time registers corresponding to each of a plurality of column lines of the synapse array and configured to store the time value that the timer outputs when an output spike signal occurs on the corresponding column line, a time difference calculator configured to calculate an occurrence time difference between occurrence of the output spike signal and occurrence of the input spike signal, a weight update circuit configured to update, in response to occurrence of the input spike signal or occurrence of the output spike signal, a weight value of the corresponding synapse circuits included in the synapse array based on a weight change amount corresponding to the occurrence time difference; and a control circuit configured to control operation of the timer, the plurality of input time registers, the plurality of output time registers, the time difference calculator, and the weight update circuit.

An operation method of an STDP learning circuit according to an embodiment of the present disclosure may comprise receiving an output spike signal from one of a plurality of columns, writing an occurrence time of the output spike signal into an output time register corresponding to a column line in which the output spike signal occurred, initializing an output overflow register corresponding to the output spike signal, obtaining an occurrence time of an input spike signal written in an input time register for each of a plurality of row lines, calculating an occurrence time difference between the occurrence time of the output spike signal and the occurrence time of the input spike signal for each of the plurality of row lines, obtaining a weight change amount according to the occurrence time difference for each of the plurality of row lines, obtaining a weight value for each of the synapse circuits corresponding to the column line in which the output spike signal occurred and updating the weight value of each of the corresponding synapse circuits in the column line in which the output spike signal occurred by applying the weight change amount to each of the corresponding synapse circuits.

### BRIEF DESCRIPTION OF THE DRAWINGS

The above and other objects and features of the present disclosure will become apparent by describing in detail embodiments thereof with reference to the accompanying drawings.

FIG. 1 is a block diagram illustrating a spike neural network circuit according to an embodiment of the present disclosure.

FIG. 2 is a circuit diagram illustrating a synapse array according to an embodiment of the present disclosure.

FIG. 3 is a diagram illustrating a weight change amount according to an occurrence time difference between an input spike signal and an output spike signal according to an embodiment of the present disclosure.

FIG. 4 is a block diagram illustrating a STDP learning circuit according to an embodiment of the present disclosure.

FIG. 5 is a block diagram illustrating an input register array according to an embodiment of the present disclosure.

FIG. 6 is a block diagram illustrating an output register array according to an embodiment of the present disclosure.

FIG. 7 is a diagram illustrating an output of a timer according to an embodiment of the present disclosure.

FIG. 8 is a diagram illustrating a value stored in registers over time when an input spike signal occurs according to an embodiment of the present disclosure.

FIG. 9 is a diagram illustrating a value stored in registers over time when an output spike signal occurs according to an embodiment of the present disclosure.

FIG. 10 is a diagram illustrating an output of a time difference calculator when an output spike signal occurs according to an embodiment of the present disclosure.

FIG. 11 is a diagram illustrating an output of a time difference calculator when an input spike signal occurs according to an embodiment of the present disclosure.

FIG. 12 is a diagram illustrating a weight change memory according to an embodiment of the present disclosure.

FIG. 13 is a flowchart illustrating an operation method of a STDP learning circuit according to an embodiment of the present disclosure.

FIG. 14 is a flowchart illustrating a step of calculating the occurrence time difference of the spike signals of FIG. 13.

FIG. 15 is a flowchart illustrating an operation method of a STDP learning circuit when an input spike signal occurs according to an embodiment of the present disclosure.

FIG. 16 is a flowchart illustrating a step of calculating the occurrence time difference between the occurrence times of the spike signals of FIG. 15.

FIG. 17 is a diagram illustrating a weight updating for each row line when an output spike signal occurs, according to an embodiment of the present disclosure.

FIG. 18 is a diagram illustrating the weight updating for each column line when an input spike signal occurs, according to an embodiment of the present disclosure.

### DETAILED DESCRIPTION

Hereinafter, embodiments of the present disclosure will be described clearly and in detail to the extent that a person skilled in the art can easily practice the present disclosure.

Components described with reference to terms such as a part or a unit, a module, a block, an or, and functional blocks shown in the drawings used in the detailed description may be implemented in a form of software, hardware, or a combination thereof. Exemplarily, the software may be machine code, firmware, embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive device, or a combination of them.

In this document, each of the phrases such as “A or B”, “at least one of A and B”, “At least one of A or B”, “A, B, or C”, “at least one of A, B, and C”, and “at least one A, B, or C” may include any one of the items listed together in the corresponding one of the phrases, or all possible combinations thereof.

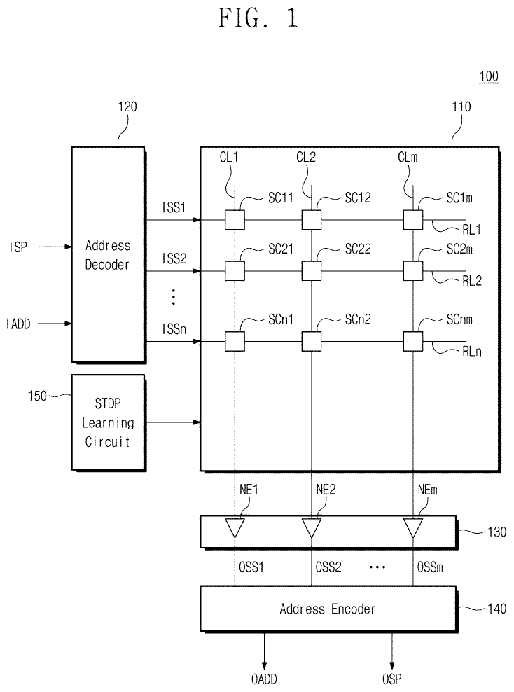

FIG. 1 is a block diagram illustrating a spike neural network circuit according to an embodiment of the present disclosure.

Referring to FIG. 1, the spike neural network circuit 100 may include a synapse array 110, an address decoder 120, a neuron array 130, an address encoder 140, and a spike-timing dependent plasticity learning circuit (hereinafter, STDP learning circuit) 150.

The synapse array may include a plurality of row lines RL1, RL2, . . . and RLn corresponding to each of a plurality of rows, a plurality of column lines CL1, CL2, . . . , and CLm corresponding to each of a plurality of columns, and a plurality of synapse circuits SC11, SC12, . . . , and SCnm connected to the plurality of row lines R1-RLn and the plurality of column lines C1-CLm. The plurality of row lines RL1-RLn and the plurality of column lines CL1-CLm may vertically intersect. The plurality of synapse circuits SC11-SCnm may be arranged in a matrix form. The synapse circuit SC11 is connected to the row line RL1 and the column line CL1. The synapse circuit SC12 is connected to the row line RL1 and the column line CL2. The synapse circuit SC21 is connected to the row line RL2 and column line CL1.

The plurality of row lines RL1-RLn may correspond to an axon of a neural network, and the plurality of column lines CL1-CLm may correspond to a membrane (or dendrite) of the neural network. The plurality of synapse circuits SC11-SCnm may define a strength of a connection between the axon and the membrane (or dendrite). The strength of the plurality of connections between the axons and the membrane (or dendrite) may be expressed as a weight value of each of the synapse circuits SC11-SCnm.

Input spike signals ISS1, ISS2, . . . , ISSn may be applied to the plurality of row lines RL1-RLn. For example, the input spike signal ISS1 refers to a spike signal applied to the row line RL1. The input spike signal ISS2 refers to a spike signal applied to the row line RL2. Each of the plurality of synapse circuits SC11-SCnm may perform a charge accumulation operation (or simply, charge operation) on the corresponding column line based on the weight value in response to the input spike signal applied through the corresponding row line. For example, when the input spike signal ISS1 is applied to the row line RL1, the synapse circuit SC11 may perform the charge accumulation operation on the column line CL1 based on the weight value of the synapse circuit SC11. The synapse circuit SC12 may perform the charge accumulation operation on the column line CL2 based on the weight value of the synapse circuit SC12. That is, each of the synapse circuits SC11 to SClm corresponding to the first row may perform the charge accumulation operation based on the individual weight value to the corresponding column line among the plurality of column lines CL1-CLm. When the input spike signal ISS2 is applied to the row line RL2, each of the synapse circuits SC21-SC2m corresponding to the second row may perform the charge accumulation operation based on the individual weight to the corresponding column line among the plurality of column lines CL1-CLm.

The charge accumulation operation may be performed in an analog manner. For example, either a charge supplying scheme or charge subtracting scheme corresponding to the weight value may be applied to the plurality of synapse circuits SC11-SCnm. The plurality of column lines CL1-CLm may have a capacitance. As an example of the charge supplying scheme, the synapse circuit SC11 may supply the charge by the weight value to the column line CL1 in response to the input spike signal ISS1. The synapse circuit SC21 may supply the charge by the weight value to the column line CL1 in response to the input spike signal ISS2. When the potential of the column line CL1 exceeds the threshold potential, the output spike signal OSS1 is fired, and the charge of the column line C11 is initialized through discharge. As an example of the charge subtracting scheme, the synapse circuit SC11 may discharge the charge accumulated on the column line CL1 by the weight value of the synapse circuit SC11 in response to the input spike signal ISS1. The synapse circuit SC21 may discharge the charge accumulated on the column line CL1 by the weight value of the synapse circuit C21 in response to the input spike signal ISS2. When the potential of the column line CL1 is less than the threshold potential, the output spike signal OSS1 is fired, and the charge of the column line CL1 may be initialized through charging. The following description is based on the charge supplying scheme for convenience of description. A person skilled in the art may understand that the synapse array 110 according to an embodiment of the present disclosure may be driven in a manner of subtracting a charge.

The address decoder 120 may receive the input address IADD and the spike input ISP. The spike input ISP may be in the form of a pulse. The address decoder 120 may output an input spike signal to a row line corresponding to the input address IADD from among the plurality of row lines RL1-RLn. For example, when the input address IARDD indicates the row line RL1, the address decoder 120 may output the input spike signal ISS1 to the row line RL1 in response to the spike input ISP. When the input address IANDD indicates the row lines RL2, the address decoder 120 may output the input spike signal ISS2 to the row lines RL2 in response to the spike input ISP.

The neuron array 130 may include a plurality of neuron circuits NE1, NE2, . . . , and NEm. Each of the plurality of neuron circuit NE1-NEm is connected to one end of each of the plurality of column lines CL1-CLm. The plurality of neuron circuits NE1-NEm may generate the output spike signals OSS1-OSSm based on the result of the charge accumulation operation and the threshold potential. When generating the output spike signals OSS1-OSSm, the plurality of neuron circuits NE1-NEm may initialize the corresponding column line. For example, when the potential of the column line CL1 exceeds the threshold potential, the neuron circuit NE1 may generate the output Spike signal OSS1 and initialize the potential of the column line CL1. When the potential of the column line CL2 exceeds the threshold potential the neuron circuit NET2 may generate the output spike signal OSS2 and initialize the potential of the column line CL2.

The address encoder 140 may receive the output spike signals OSS1-OSSm. When the address encoder 140 receives each of the output spike signals OSS1-OSSm, the address encoder may output the output address OADD of the corresponding column line and the spike output OSP. For example, when the address encoder 140 receives the output spike signal OSS1, the address encoder outputs the output address OADD corresponding to the column line CL1 and the spike output OSP. When the address encoder 140 receives the output spike signal OSS2, the address encoder 140 may output the output addresses OADD corresponding to the column line CL2 and spike outputs OSP.

The STDP learning circuit 150 may update the weight values of the plurality of synapse circuits SC11-SCnm. When any one of the input spike signals ISS1-ISSn or output spike signals OSS1-OSSm occurs, the STDP learning circuit 150 may update the weight value of all or a portion of the plurality of synapse circuits SC11-SCnm. For example, when the input spike signal ISS1 among the plurality of input spike signals ISS1-ISSn occurs, the STPD learning circuit 150 may update the weight value of all or a portion of the synapse circuits SC11-SCIm corresponding to the first row. When the input spike signal ISS2 among the plurality of input spike signals ISS1-ISSn occurs, the STDP learning circuit 150 may update the weight value of all or a portion of the synapse circuits SC21-SC2m corresponding to the second row. When the output spike signal OSS1 among the plurality of output spike signals OSS1-OSSm occurs, the STDP learning circuit 150 may update the weight value of all or a portion of the synapse circuits SC11-SCn1 corresponding to the first column. When the output spike signal OSS2 among the plurality of output spike signals OSS1-OSSm occurs, the STDP learning circuit may update the weight value of all or a portion of the synapse circuits SC12-SCn2 corresponding to the second column.

The STDP learning circuit 150 may use an occurrence time difference between occurrence time of the output spike signal and occurrence time of the input spike signal to update the weight values of the synapse circuits SC11-SCnm. When an output spike signal occurs, the STDP learning circuit 150 may determine the weight change amount for each synapse circuit based on the time difference between the occurrence time of the output spike signal and the occurrence times of input spike signals that preceded the output spike signal. When an input spike signal occurs, the STDP learning circuit 150 may also determine the weight change amount for each synapse circuit based on the occurrence time difference between the occurrence time of the input spike signal and the occurrence times of output spike signals that preceded the input spike signal.

For example, when the output spike signal OSS1 occurs, the STDP learning circuit 150 may determine the weight change amount based on the occurrence time difference between the occurrence time of the output spike signal OSS1 and the occurrence times of the plurality of input spike signals ISS1-ISSn that preceded the output spike signal OSS1. When the input spike signal ISS1 occurs, the STDP learning circuit 150 may determine the weight change amount based on the occurrence time difference between the occurrence time of the input spike signal ISS1 and the occurrence times of the plurality of output spike signals OSS1-OSSm that preceded the input spike signal ISS1. The STDP learning circuit 150 may perform learning of the spike neural network circuit 100 by updating the weight values of the synapse circuits SC11-SCnm based on the time difference between the occurrence times of the spike signals. The weight change amount may be determined by a preset STDP curve.

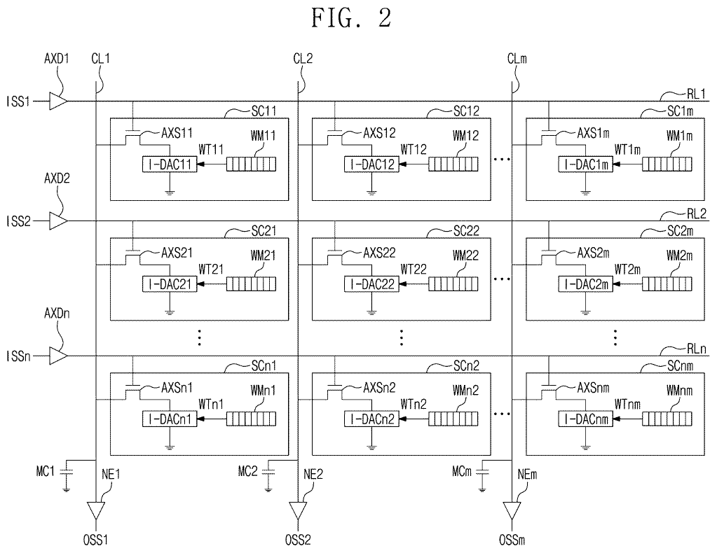

FIG. 2 is a circuit diagram illustrating a synapse array according to an embodiment of the present disclosure.

Referring to FIG. 2, each of the plurality of synapse circuits SC11-SCnm may include a weight memory and a digital-to-analog converter.

The plurality of weight memories WM11, WM12, . . . , and WMnm may store weight values of a corresponding synapse circuit. For example, the weight memory WM11 may store the weight value WT11 of the synapse circuit SC11. The weight memory WM12 may store the weight value SW12 of the synapse circuit SC12.

The plurality of digital-to-analog converters I-DAC11, I-DAC12, . . . I-DACnm may supply a charge to a corresponding column line among the plurality of column lines CL1-CLm according to a corresponding input spike signal among the plurality of input spike signals ISS1-ISSn.

Each of the plurality of synapse circuits SC11-SCnm may include a corresponding axon switch. The axon switch connects a digital-to-analog converter and a column line. The axon switch is turned on by a pulse of an input spike signal. For example, the axon switch may be implemented as a MOSFET. One end of a source/drain of the axon switch is connected to the column line, the other end of the source/drain is connected to the digital-to-analog converter, and a gate end may be connected to a row line.

For example, the synapse circuit SC11 may include an axon switch AXS11. One end of a source/drain of the axon switch AXS11 may be connected to the column line CL1, and the other end of the source/drain of the axon switch AXS11 may be connected to the digital-to-analog converter I-DAC11. The gate end of the axon switch AXS11 may be connected to the row line RL1. One end of the source/drain of the AXS12 may be connected to the column line CL2, and the other end of the axon switch AXS12 may be connected to the digital-to-analog converter I-DAC12. The gate end of the AXS12 may be connected to the row line RL1. The one end of the source/drain of the AXS21 may be connected to the row line RL1, and the other end of the source/drain of the AXS21 may be connected to digital-to-analog converter I-DAC21. The gate end of the AXS21 may be connected to the row line RL2.

When the input spike signal ISS1 is applied to the row line RL1, the axon switches AXS11, AXS12, . . . and AXS1m corresponding to the first row are turned-on. The digital-to-analog converter I-DAC11 may supply the charge corresponding to the weight value WT11 stored in the weight memory WM11 to the column line CL1 through the axon switch AXS11. The digital-to-analog converter 1-DAC12 may supply the charge corresponding to the weight value WT12 stored in the weight memory WM12 to the column line C12 through the axon switching AXS12.

The synapse array 110 may include the axon drivers AXD1, AXD2, . . . and AXDn corresponding to the plurality of row lines RL1-RLn, respectively. The plurality of axon drivers AXD1-AXDn may amplify the input spike signals ISS1-ISSn. The amplified input spike signals ISS1-ISSn are transmitted to the plurality of the row lines RL1-RLn.

The synapse array 110 may include a plurality of membrane capacitors MC1, MC2, . . . and MCm corresponding to each of the plurality of column lines CL1-CLm. Each of the plurality of membrane capacitors MC1-MCm may store a charge supplied to the column lines CL1-CLm. Accordingly, the potential of the column lines CL2-CLm may be maintained.

When the synapse circuits SC11-SCnm supply the charge to the plurality of column lines CL1-CLm, the potential of each of the plurality of column line CL1-CLm may increase. The neuron circuits NE1-NEm generate the output spike signals OSS1-OSSm when the potential of each of the plurality of column lines CL1-CLm reaches (or exceeds) a threshold potential. The neuron circuits NE1-NEm may initialize the corresponding potential by discharging the charges of the membrane capacitors MC1-MCm.

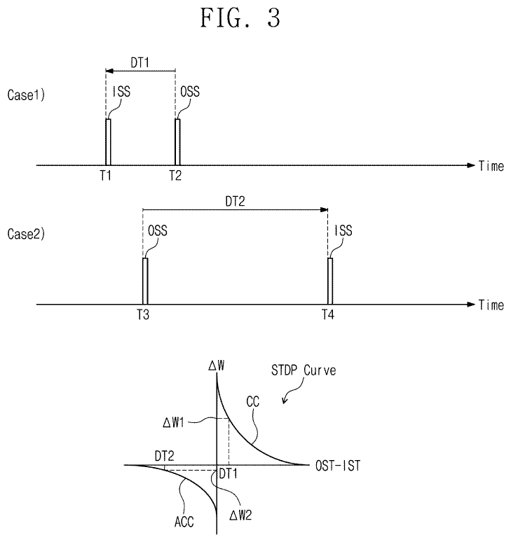

FIG. 3 is a diagram illustrating a weight change amount according to an occurrence time difference between an input spike signal and an output spike signal according to an embodiment of the present disclosure.

Referring to FIG. 3, the weight change amount ΔW may be determined according to a difference between the occurrence time OST of the output spike signal and the occurrence time IST of the input spike signal.

The first case (Case1) is a causal case (CC) in which an input spike signal occurred first, and an output spike signal occurred later. The input spike signal ISS occurred at T1, and the output spike signal OSS occurred (or is generated) at T2. Since the input spike signal ISS occurs earlier than the output spike signal OSS, the occurrence time difference DT1 calculated by subtracting T1 from T2 corresponds to a positive number.

The second case (Case2) is an anti-causal case (ACC) in which an output spike signal occurred first, and an input spike signal occurred later. The output spike signal OSS occurred at T3, and the input spike signal ISS occurred at T4. Since the output spike signal OSS occurs earlier than the input spike signal ISS, the occurrence time difference DT2 calculated by subtracting T4 from T3 corresponds to a negative number.

The STDP curve is divided into a portion corresponding to the causal case (CC) and a portion corresponding to the anti-causal type (ACC). The STDP curve represents a weight change amount ΔW according to an occurrence time difference OST-IST between the input spike signal and the output spike signal.

The STDP curve shows that the magnitude of weight change amount ΔW is larger as the occurrence time difference OST-IST between the input spike signal and the output spike signal is smaller. When the occurrence time difference OST-IST is positive and relatively small, the weight change amount ΔW is relatively large. The updated weight value may increase significantly. When the occurrence times difference OST-IST is positive and relatively large, the weight change amount ΔW is relatively small. The updated weight value may increase slightly. When the occurrence time difference OST-IST is negative and its absolute value is relatively small, the weight change amount ΔW is negative and its magnitude is relatively large. The updated weight value may decrease significantly. When the occurrence time difference OST-IST is negative and its absolute value is relatively large, the weight change amount ΔW is negative and its magnitude is relatively small. The updated weight value may decrease slightly.

The STDP curve is used to learn (or train) the spike neural network circuit 100 according to the causal relationship between the input spike signal and the output spike signal. During a learning process, the weight value of the synapse circuit may be updated according to the STDP curve.

STDP-based neural network learning is classified as a type of local learning because the learning is determined by the temporal relationship between a specific input spike signal and its corresponding output spike signal.

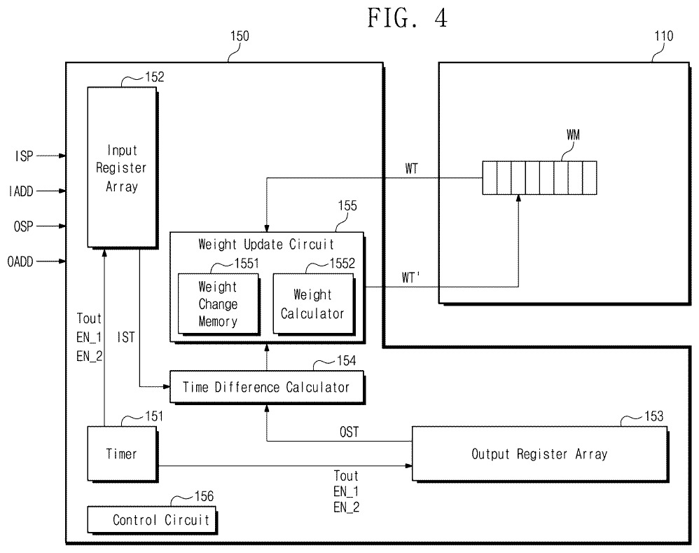

FIG. 4 is a block diagram illustrating a STDP learning circuit according to an embodiment of the present disclosure.

Referring to FIG. 4, the STDP learning circuit 150 may include a timer 151, an input register array 152, an output register array 153, a time difference calculator 154, a weight update circuit 155, and a control circuit 156.

The STDP learning circuit 150 may receive a spike input ISP, an input address IADD, a spike output OSP, and an output address OADD. The spike input ISP and the input address IADD may be used to determine the occurrence of the input spike signal and its location. The spike output OSP and the output address OADD may be used to determine the occurrence of the output spike signal and its location. A STDP learning circuit 150 may identify a spike signa based on the spike input ISP, the input address IAAD, the spike output OSP, and the output address OADD. The STDP learning Circuit 150 may directly sense spike signals from a plurality of row lines or a plurality of column lines.

The timer 151 may output a time value Tout that increases over time. The time value Tout may be provided to the input register array 152 or the output register array 153. The timer 151 may output a first enable signal EN_1 or a second enable signal EN_2. Each of the first enable signal EN_1 and the second enable signal EN_2 may be provided to the input register array 152 and the output register array 153. The timer 151 may initialize a time value Tout in response to the time value Tout reaching a maximum time value. The timer 151 may output the increasing time value and initialize the time value Tout, repeatedly. That is, the time value Tout output by the timer 151 may have a sawtooth shape. The timer 151 may alternately output one of the first enable signal EN_1 and the second enable signal EN_2 in response to the time value Tout reaching the maximum time value. For example, when the time value Tout reaches the maximum time value, the first enable signal EN_1 may be output. When the time value Tout reaches the maximum time value again after being initialized, the second enable signal EN_2 may be output. The first enable signal EN_1 and the second enable signal EN_2 have a specific period and may be output alternately.

The input register array 152 may include a plurality of input time registers. Each of the plurality of input time registers may correspond to a plurality of row lines RL1-RLn. For example, an input time register corresponding to a first row may correspond to a row line RL1, and an input time register corresponds to a second row may correspond to the row line RL2.

The plurality of input time registers may store the time value Tout output by the timer 151 when an input spike signal occurs on a corresponding row line. For example, when the input spike signal ISS1 occurs on the first row, the time value Tout when the input spike signal ISS1 occurs may be stored in the input time register corresponding to the first row. When the input spike signal ISS2 occurs on the second row, the time value Tout when the input spike signal ISS2 occurs may be stored in the input time register corresponding to the second row.

The output register array 153 may include a plurality of output time registers. Each of the plurality of output time registers may correspond to a plurality of column lines CL1-CLm. For example, an output time register corresponding to a first column may correspond to the column line CL1, and an output time register corresponds to a second column may correspond to the column line CL2.

The plurality of output time registers may store a time value Tout output by the timer 151 when an output spike signal occurs on a corresponding column line. For example, when the output spike signal OSS1 occurs on the first column, the time value Tout when the output spike signal OSS1 occurs may be stored in the output time register corresponding to the first column. When the output spike signal OSS2 occurs on the second column, the time value Tout when the output spike signal OSS2 occurs may be stored in the output time register corresponding to the second column.

The time difference calculator 154 may receive the occurrence time IST of the input spike signal from the input register array 152 and receive the occurrence time OST of the output spike signal from the output register array 153. The time difference calculator 154 may calculate an occurrence time difference between the occurrence time IST of the input spike signal and the occurrence time OST of the output spike signal. The time difference calculator 154 may output a calculation result. The time difference calculator 154 may output an absolute value of the calculated result to the weight update circuit 155.

In response to the occurrence of the input spike signal or the generation of the output spike signal, the weight update circuit 155 may update the weight values of all or a portion of the plurality of synapse circuits based on the weight change amount corresponding to the occurrence time difference received from the time difference calculator 154. When the input spike signal occurs, the weight update circuit 155 may receive the occurrence time difference from the time difference calculator 154. The weight update circuit 155 may obtain the weight change amount from the portion of the STDP curve corresponding to the anti-causal case. The weight change amount obtained at this point may be a negative number. When the output spike signal occurs the weight update circuit 155 may obtain the weight change amount from the portion of the STDP curve corresponding to the causal case. The weight change amount obtained at this point may be a positive number.

The weight update circuit 155 may obtain the weight value WT from the weight memory WM of the target synapse circuit among the plurality of synapse circuits. The weight update circuit 155 may generate an updated weight value WT′ by applying the weight change amount to the weight value WT. The weight update circuit 155 may write the updated weight value WT′ to the weight memory WM. Accordingly, the weight value WT stored in the weight memory WM of the target synapse circuit may be replaced with the updated weight value WT.

The weight update circuit 155 may include a weight change memory 1551 and a weight calculator 1552.

The weight change memory 1551 may store a weight change amount according to an occurrence time difference. According to a type of spike signals, the weight change memory 151 may provide a weight change amount corresponding to a causal case or a weight change amount corresponding to an anti-causal case. For example, the weight change memory 1551 may provide the weight change amount corresponding to the causal case to the weight calculator 1552 in response to occurrence of an output spike signal. The weight change memory 1511 may provide the weight change amount corresponding to the anti-causal case to the weight calculator 1552 in response to the occurrence of an input spike signal.

The weight calculator 1552 may update the weight value of the target synapse circuit among the plurality of synapse circuits of the synapse array 110. The weight calculator 1552 may read the weight value WT from the weight memory WM of the target synapse circuit. The weight calculator 1552 may obtain the target weight change amount by referring to the weight change memory 1551 based on the occurrence time difference received from the time difference calculator 154. The target weight change amount is an adjustment value used to update the weight value WT of the target synapse circuit based on STDP learning. The weight calculator 1552 may generate an updated weight value WT′ by applying the target weight change amount to the weight value WT obtained from the weight memory WM. The weight calculator 1552 may write the updated weight value WT′ into the weight memory WM. The weight memory WM may store the weight value WT′ updated from the previous weight value WT. When an input spike signal occurs, the target synapse circuit may perform a charge operation based on the updated weight value WT′.

The control circuit 156 may manage and control various operations of the STDP learning circuit 150. The control circuit 156 may detect the occurrence time of the input spike signal or the output spike signal with reference to the time value Tout provided from the timer 151 and may write the occurrence time to the input register array and the output register array. The control circuit 156 may read time information stored in the input register array 152 and the output registers array 153 and may control the time difference calculator 154 to calculate an occurrence time difference between spike signals. A value calculated by the time difference calculator 154 is provided to the weight update circuit 155. The control circuit 156 may control the weight update circuit 155 to read a weight change amount and to change the weight value WT of the target synapse circuit to an updated weight value WT′. The control circuit 156 may manage a sequential flow of an entire learning process in synchronization with the occurrence of the input spike signal and the output spike signal, and coordinate signal transmission and operation order between each component.

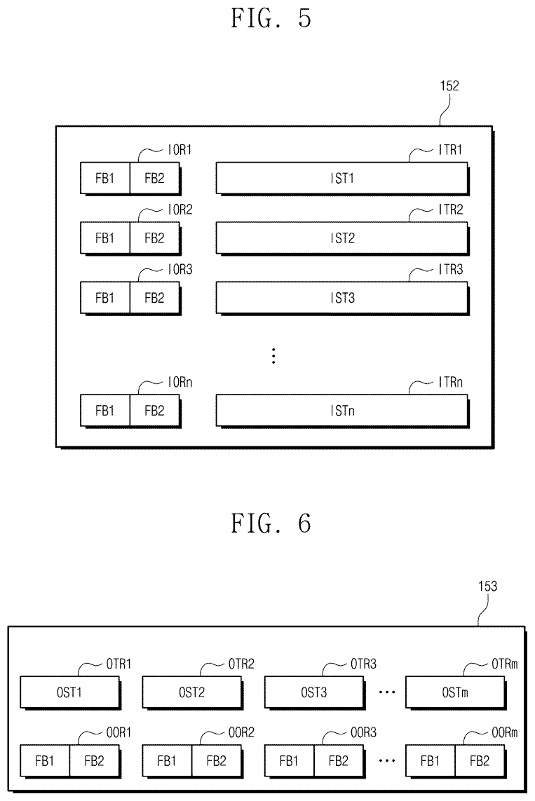

FIG. 5 is a block diagram illustrating an input register array according to an embodiment of the present disclosure.

Referring to FIG. 5, the input register array 152 may include input time registers ITR1-ITRn corresponding to each of a plurality of row lines.

Each of the input time registers ITR1-ITRn may store an occurrence time of an input spike signal occurred on a corresponding row. For example, the input time register ITR1 may store the occurrence time IST1 of the input spike signal corresponding to the first row. The input time register ITR2 may store the occurrence time IST2 of the input spike signal corresponding to the second row. The occurrence times IST1, IST, . . . and ISTn of the input spike signals may be a time value Tout provided from the timer 151 when the corresponding input spike signal occurs.

The input register array 152 may further include a plurality of input overflow registers IOR1, IOR2, . . . , and IORn corresponding to each of the plurality of row lines. Each of the plurality of input over flow registers IOR1-IORn may include a first flag bit FB1 and a second flag bit FB2. For example, the input overflow register IOR1 corresponds to the input time register ITR1, and the input overflow resistor IOR2 corresponds to the input times register ITR2. The first flag bit FG1 and the second flag bit FG2 are used to check whether time has elapsed sufficiently. The first flag bit FG1 may be toggled from a first value (e.g., 0) to a second value (e.g., 1) in response to the first enable signal EN_1 provided from the timer 151. The second flag bit FP2 may be toggled from the first value to the second value in response to the second enable signal EN_2 provided from the timers 151. The first flag hit FB1 and the second flag bit FB2 may be initialized to the first value when the input spike signal occurs on the corresponding row line.

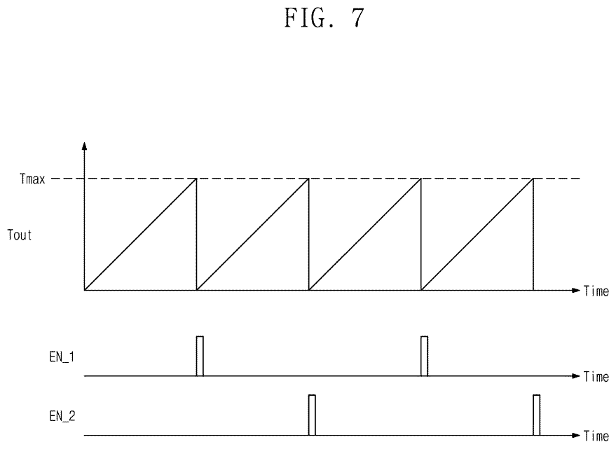

FIG. 6 is a block diagram illustrating an output register array according to an embodiment of the present disclosure.

Referring to FIG. 6, the output register array 153 may include output time registers OTR1-OTRm corresponding to each of a plurality of column lines.

Each of the output time registers OTR1-OTRm may store an occurrence time of an output spike signal occurred on a corresponding column. For example, the output time register OTR1 may store the occurrence time OST1 of the output spike signal occurred corresponding to the first column. The output time register OTR2 may store an occurrence time OST2 of the output spike signal corresponding to the second column. The occurrence times OST1, OST, . . . and OSTm of the output spike signals may be a time value Tout provided from the timer 151 when the output spike signal occurs.

The output register array 153 may further include a plurality of output overflow registers OOR1, OOR2, . . . , and OORm corresponding to each of the plurality of column lines. Each of the plurality of output overflow registers OOR1-OORm may include a third flag bit FB3 and a fourth flag bit FB4. For example, the output overflow register OOR1 corresponds to the output time register OTR1, and the output overflow resistor OOR2 corresponds to the output times register OTR2. The third flag bit FG3 and the fourth flag bit FG4 are used to check whether time has elapsed sufficiently. The third flag beat FB3 may be toggled from a first value (e.g., 0) to a second value (e.g., 1) in response to the first enable signal EN_1 provided from the timer 151. The fourth flag bit FF4 may be toggled from the first value to the second value in response to the second enable signal EN_2 provided from the timers 151. The third flag bit FB3 and the fourth flag bit FB4 may be initialized to the first value when the output spike signal occurs on the corresponding column line.

FIG. 7 is a diagram illustrating an output of a timer according to an embodiment of the present disclosure.

Referring to FIGS. 4 and 7, the timer 151 may output a time value Tout that increases over time.

The timer 151 may initialize a time value Tout in response to the time value Tout reaching a maximum time value Tmax. Then the timer 151 may output an increasing time value Tout and initialize the time value Tout repeatedly. In this case, the time value Tout output by the timer 151 may have a sawtooth shape.

The timer 151 may alternately output one of the first enable signal EN_1 and the second enable signal EN_2 in response to the time value Tout reaching the maximum time value Tmax. For example, when the time value Tout reaches the maximum time value Tmax, the first enable signal EN_1 may be output. When the time value Tout reaches the maximum time value Tmax again after being initialized, the second enable signal EN_2 may be output. The first enable signal EN_1 and the second enable signal EN_2, which have a specific period, may be alternately output.

The maximum time value Tmax may be a limited time value of the timer. The maximum time value Tmax may be determined based on the performance of the timer or the STDP learning algorithm. The connection strength of the spike signals exceeding the maximum time value Tmax may be negligible. For example, when an output spike signal occurs, synapse circuits corresponding to input spike signals exceeding the minimum time value Tmax among the input spike signals occurred before the output spike signal may be excluded from the weight update target.

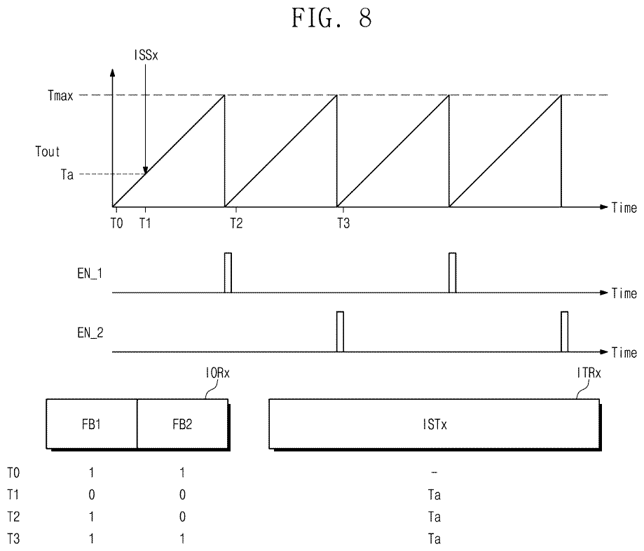

FIG. 8 is a diagram illustrating a value stored in registers over time when an input spike signal occurs according to an embodiment of the present disclosure.

Referring to FIG. 8, TO is a time point before the input spike signal ISSx occurs. T1 is a time point when the input spike signal ISSx occurs. T2 is a time point when the output of the timer 151 is first initialized after the input spike signal ISSx occurred. T3 is a time point when the output of the timer 151 is secondly initialized.

At TO, both the first flag bit FB1 and the second flag bit FB2 have 1. The occurrence time ISTx of the input spike signal in the input time register ITRx may be ignored.

At T1, the time value Ta output by the timer 151 according to the occurrence of the input spike signal ISSx may be stored in the input time register ITRx. In this case, each of the first flag bit FB1 and the second flag bit FB2 may be initialized to 0.

At T2, a first enable signal EN_1 is generated due to initialization of the timer 151. The first flag bit FB1 of the input overflow register IORx may be toggled from 0 to 1 in response to the first enable signal EN_1.

At T3, a second enable signal EN_2 is generated due to initialization of the timer 151. The second flag bit FB2 of the input overflow register IORx may be toggled from 0 to 1 in response to the second enable signal EN_2.

After T1, when at least the maximum time value Tmax has elapsed, at least one of the first flag bit FB1 and the second flag bit FB2 has 1. The flag bits FB1 and FB2 may be used to check the extent to which time has elapsed since the input spike signal ISSx occurred. When both the first flag bit FB1 and the second flag bit FB2 are 0, it may be determined that the input spike signal ISSx has been generated relatively recently. When only one of the first flag bit FB1 or the second flag bit FB2 is 0 (i.e., different from each other), it may be determined to have elapsed about halfway since the input spike signals ISSx occurred, and when both the first Flag bit FB1 or the second flag bit BF2 are 1, it may be determined as the input spike signal ISSx have occurred relatively long ago.

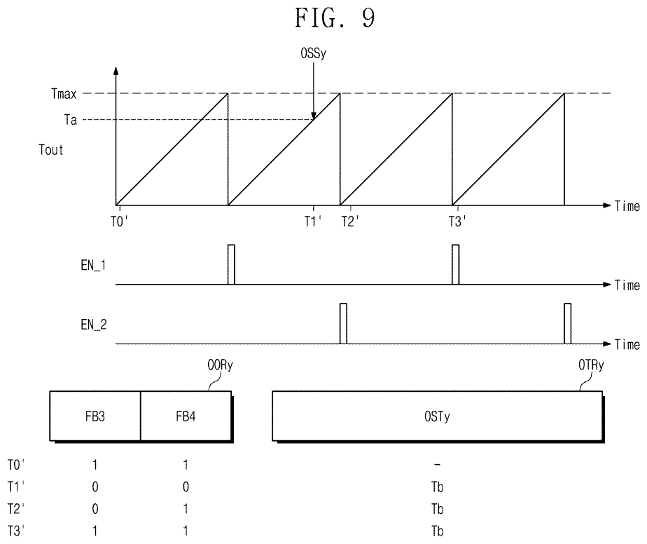

FIG. 9 is a diagram illustrating a value stored in registers over time when an output spike signal occurs according to an embodiment of the present disclosure.

Referring to FIG. 9, T0′ is a time point before the output spike signal OSSy occurs. T1′ is a time point when the output spike signal OSSy Occurs, and T2′ is a time point when the output of the timer 151 is first initialized after the output spike signal OSSy occurred. T3′ is a time point when the output of the timer 151 is secondly initialized.

At T0′, both the third flag bit FB3 and the fourth flag bit FB4 have 1. The occurrence time OSTy of the output spike signal in the output time register OTRy may be ignored.

At T1′, the time value Tb output by the timer 151 according to the occurrence of the output spike signal OSSy may be stored in the output time register OTRy. In this case, each of the third flag bit FB3 and the fourth flag bit FB4 may be initialized to 0.

At T2′, a first enable signal EN_1 is generated due to initialization of the timer 151. The third flag bit FB3 of the output overflow register OORy is toggled from 0 to 1 in response to the first enable signal EN_1.

At T3′, a second enable signal EN_2 is generated due to initialization of the timer 151. The fourth flag bit FB4 of the output overflow register OORy is toggled from 0 to 1 in response to the second enable signal EN_2.

After T1′, when at least the maximum time value Tmax has elapsed, at least one of the third flag bit FB3 and the fourth flag bit FB4 has 1. The flag bits FB3 and FB4 may be used to check the extent to which time has elapsed since the output spike signal OSSy occurred. When both the third flag bit FB3 and the fourth flag bit FB4 are 0, it may be determined that the output spike signal OSSy has been generated relatively recently. When only one of the third flag bit FB3 or the fourth flag bit FB4 is 0 (i.e., different from each other), it may be determined to have elapsed about a middle time since the output spike signals OSSy occurred, and when both the third flag bit FB3 or the fourth flag bit FB4 are 1, it may be determined as that the output spike signal OSSy have occurred relatively long ago.

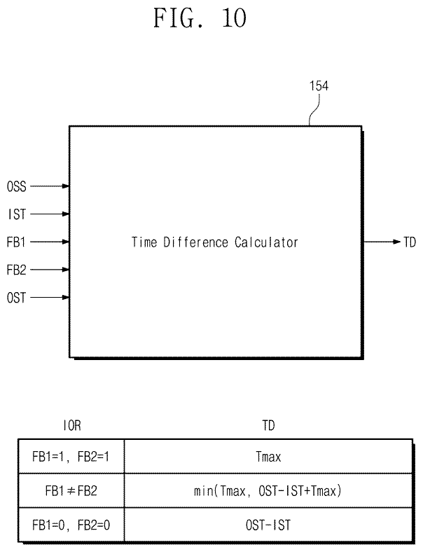

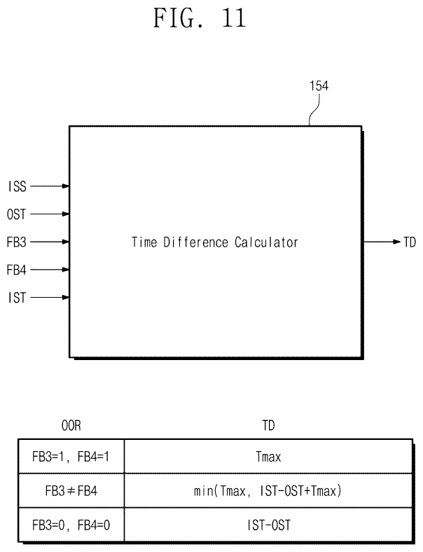

FIG. 10 is a diagram illustrating an output of a time difference calculator when an output spike signal occurs according to an embodiment of the present disclosure.

Referring to FIG. 10, when the output spike signal OSS occurs, the time difference calculator 154 may output the occurrence time difference TD based on the occurrence time IST of the input spike signal, the first flag bit FB1, the second flag bit FB2, and the occurrence time OST of the output spike signal.

When both the first flag bit FB1 and the second flag bit FB2 are 1, the time difference calculator 154 may output the maximum time value Tmax when outputting the occurrence time difference TD value.

When the first flag bit FB1 and the second flag bit FB2 are different (i.e., one is 0 and the other is 1), the time difference calculator 154 may output the occurrence time difference TD value, which is a smaller value of two quantities: the maximum time value Tmax and calculated value OST-IST+Tmax, obtained by subtracting the occurrence time IST of the input spike signal from the occurrence time OST of the output spike signal and adding the maximum time value T max. When the occurrence time interval between the output spike signal OSS and the input spike signal ISS is less than or equal to the maximum time value Tmax, a value corresponding to the occurrence time interval may be output. When the occurrence time interval between the input spike signal ISS and the output spike signal OSS is greater than the maximum time value max, the maximum time value Tmax may be output. Accordingly, even when the timer 151 is initialized between the input spike signal ISS and the output spike signa OSS, the time difference calculator 154 may determine the time interval between the spike signals.

When both the first flag bit FB1 and the second flag bit FB2 are 0, the time difference calculator 154 may output a value OST-IST obtained by subtracting the occurrence time IST of the input spike signal from the occurrence time OST of the output spike signal. When both the first and second flag bits FB1 and FB2 are 0, initialization of the timer 151 does not occur between the input spike signal and the output spike signal, and a time interval between the spike signals may be determined through a simple subtraction operation.

FIG. 11 is a diagram illustrating an output of a time difference calculator when an input spike signal occurs according to an embodiment of the present disclosure.

Referring to FIG. 11, when the input spike signal ISS occurs, the time difference calculator 154 may output the occurrence time difference TD based on the occurrence time OST of the output spike signal, the third flag bit FB3, the fourth flag bit FB4, and the occurrence time IST of the input spike signal.

When both the third flag bit FB3 and the fourth flag bit FB4 are 1, the time difference calculator 154 may output the maximum time value Tmax when outputting the occurrence time difference TD value.

When the third flag bit FB3 and the fourth flag bit FB4 are different (i.e., one is 0 and the other is 1), the time difference calculator 154 may output the occurrence time difference TD value, which is a smaller value of two quantities: the maximum time value Tmax and calculated value IST-OST+Tmax, obtained by subtracting the occurrence time OST of the output spike signal from the occurrence time IST of the input spike signal and adding the maximum time value T max. When the occurrence time interval between the input spike signal ISS and the output spike signal OSS is less than or equal to the maximum time value Tmax, a value corresponding to the occurrence time interval may be output. When the occurrence time interval between the output spike signal OSS and the input spike signal ISS is greater than the maximum time value Tmax, the maximum time value Tmax may be output. Accordingly, even when the timer 151 is initialized between the input spike signal ISS and the output spike signal OSS, the time difference calculator 154 may determine the time interval between the spike signals.

When both the third flag bit FB3 and the fourth flag bit FB4 are 0, the time difference calculator 154 may output a value IST-OST obtained by subtracting the occurrence time OST of the output spike signal from the occurrence time IST of the input spike signal. When both the third and fourth flag bits FB3 and FB4 are 0, initialization of the timer 151 does not occur between the input spike signal and the output spike signal, and a time interval between the spike signals may be determined through a simple subtraction operation.

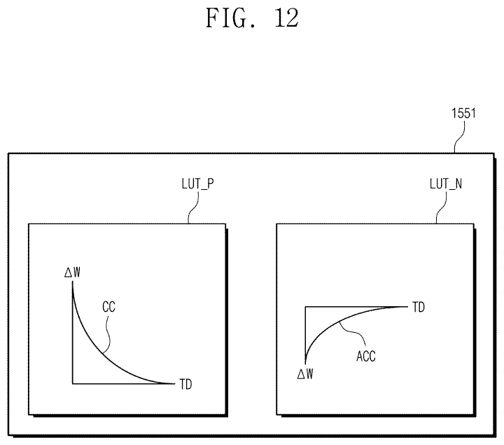

FIG. 12 is a diagram illustrating a weight change memory according to an embodiment of the present disclosure.

Referring to FIG. 12, the weight change memory 1551 may include a first lookup table LUT_P for storing weight change amounts according to a causal case CC and a second lookup table LUT_N for storing weight change amounts according to an anti-causal case ACC.

The first lookup table LUT_P is referred to when the output spike signal occurs. The first lookup Table LUT_P stores weight change amounts ΔW corresponding to the causal case CC in the STDP curve of FIG. 3. The weight change amounts ΔW may have a positive value.

The second lookup table LUT_N is referred to when the input spike signal occurs. The second lookup Table LUT_N stores the weight change amounts ΔW corresponding to the anti-causal case ACC among the STDP curve types of FIG. 3. The weight change amounts ΔW may have a negative value.

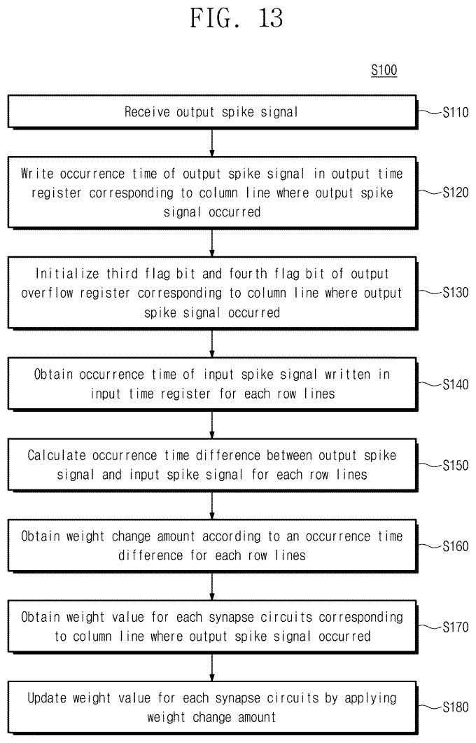

FIG. 13 is a flowchart illustrating an operation method of the STDP learning circuit according to an embodiment of the present disclosure.

Referring to FIG. 13, an operation method S100 of the STDP learning circuit may include a step S110 of receiving an output spike signal of one column from among a plurality of columns.

The operation method S100 of the STDP learning circuit may include a step S120 of writing an occurrence time of the output spike signal in an output time register corresponding to a column line where the output spike signal occurs from among the plurality of column lines. A time value output from the timer may be written in the output time register.

The operation method S100 of the STDP learning circuit may include a step S130 of initializing a third flag bit and a fourth flag bit of the output overflow register corresponding to the column line where the output spike signal occurred. The third flag bit and the fourth flag bit may be initialized to a first value. Meanwhile, the third flag bit and fourth flag bit may be toggled to a second value based on the first enable signal or the second enable signal output from the timer.

On the other hand, the timer outputs a time value that increases over time, and when the time value reaches the maximum time value, the time value is initialized. At this time, one of the first enable signal or the second enable signal may be output alternately.

The operation method S100 of the STDP learning circuit may include a step S140 of obtaining the occurrence time of the input spike signal written in the input time register for each of the plurality of row lines. The first flag bit and the second flag bit stored in the input overflow register may be provided.

The operation method S100 of the STDP learning circuit may include a step S150 of calculating an occurrence time difference between the output spike signal and the input spike signal for each of the plurality of row lines. The occurrence time difference may be provided within a range of a maximum time value output by the timer.

The operation method S100 of the STDP learning circuit may include a step S160 of obtaining a weight change amount according to an occurrence time difference for each of the plurality of row lines. The weight change amount may be based on a causal case.

The operation method S100 of the STDP learning circuit may include a step S170 of obtaining a weight value for each of the synapse circuits corresponding to the column line where the output spike signal occurred.

The operation method S100 of the STDP learning circuit may include a step S180 of updating the weight value for each of the synapse circuits by applying the weight change amount. The updated weight value may be determined by applying the weight change amount obtained in step S160 to the weight value obtained in step S170. The updated weight value may be written into a weight memory of each of the synapse circuits.

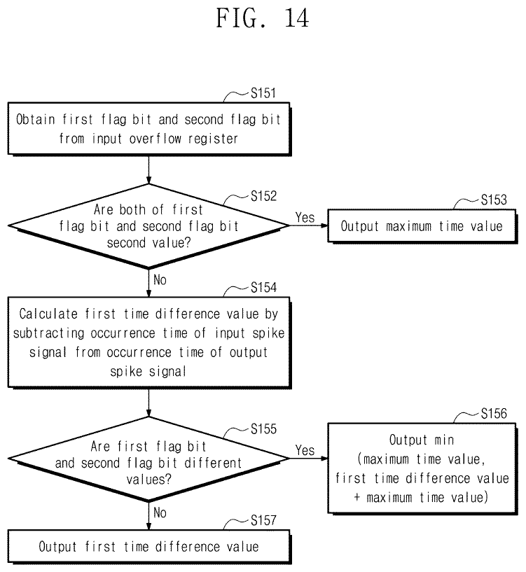

FIG. 14 is a flowchart illustrating a step of calculating the occurrence time difference of the spike signals of FIG. 13.

The step S150 of calculating the occurrence time difference of the spike signals may include a step S151 of obtaining the first flag bit and the second flag bit from the input overflow register.

The step S150 of calculating the occurrence time difference of the spike signals may include a step S152 of determining whether both the first flag bit and the second flag bit are the second value (e.g., 1).

The step S150 of calculating the occurrence time difference of the spike signals may include a step S153 of outputting a maximum time value when both the first flag bit and the second flag bit are second value (S152—Yes).

The step S150 of calculating the occurrence time difference of the spike signals may include a step S154 of calculating a first time difference value that is a value obtained by subtracting the occurrence time of the input spike signal from the occurrence time of an output spike signal when both the first flag bit and the second flag bit are not the second value (S152—No).

The step S150 of calculating the occurrence time difference of the spike signals may include a step S155 of determining whether the first flag bit and the second flag bit are different values.

The step S150 of calculating the occurrence time difference of the spike signals may include a step S156 of outputting a smaller value of two quantities: the maximum time value and a sum of the first time difference value and the maximum time value when the first flag bit and the second flag bit are different values (S155—Yes).

The step S150 of calculating the occurrence time difference of the spike signals may include a step S157 of outputting the first time difference value when the first flag bit and the second flag bit are not different values (S155—No). This condition occurs when both flag bits are the first value (for example, 0).

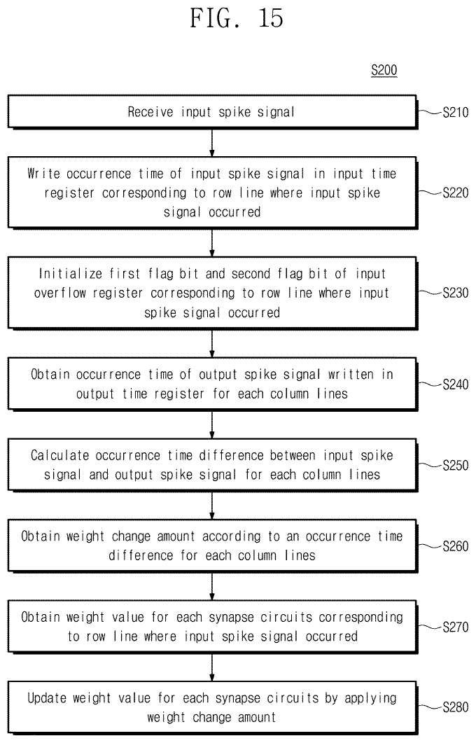

FIG. 15 is a flowchart illustrating an operation method of a STDP learning circuit when an input spike occurs according to an embodiment of the present disclosure.

Referring to FIG. 15, an operation method S200 of the STDP learning circuit may include a step S210 of receiving an input spike signal of one row from among a plurality of row lines.

The operation method S200 of the STDP learning circuit may include a step S220 of writing an occurrence time of the input spike signal in an input time register corresponding to a row line where the input spike signal occurs from among the plurality of row lines. A time value output from the timer may be written in the input time register.

The operation method S200 of the STDP learning circuit may include a step S130 of initializing a first flag bit and a second flag bit of the input overflow register corresponding to the row line where the input spike signal occurred. The first flag bit and the second flag bit may be initialized to a first value. Meanwhile, the first flag bit and second flag bit may be toggled to a second value based on the first enable signal or the second enable signal output from the timer.

On the other hand, the timer outputs a time value that increases over time, and when the time value reaches the maximum time value, the output time value is initialized. At this time, one of the first enable signal or the second enable signal may be output alternately.

The operation method S200 of the STDP learning circuit may include a step S240 of obtaining the occurrence time of the output spike signal written in the output time register for each of the plurality of column lines. The third flag bit and the fourth flag bit stored in the output overflow register may be provided.

The operation method S200 of the STDP learning circuit may include a step S250 of calculating an occurrence time difference between the input spike signal and the output spike signal for each of the plurality of column lines. The occurrence time difference may be provided within a range of a maximum time value output by the timer.

The operation method S200 of the STDP learning circuit may include a step S260 of obtaining a weight change amount according to an occurrence time difference generated for each of the plurality of column lines. The weight change amount may be based on an anti-causal case.

The operation method S200 of the STDP learning circuit may include a step S270 of obtaining a weight value for each of the synapse circuits corresponding to the row line where the input spike signal occurred.

The operation method S200 of the STDP learning circuit may include a step S280 of updating the weight value for each of the synapse circuits by applying the weight change amount. The updated weight value may be determined by applying the weight change amount obtained in step S260 to the weight value obtained in step S170. The updated weight value may be written into a weight memory of each of the synapse circuits.

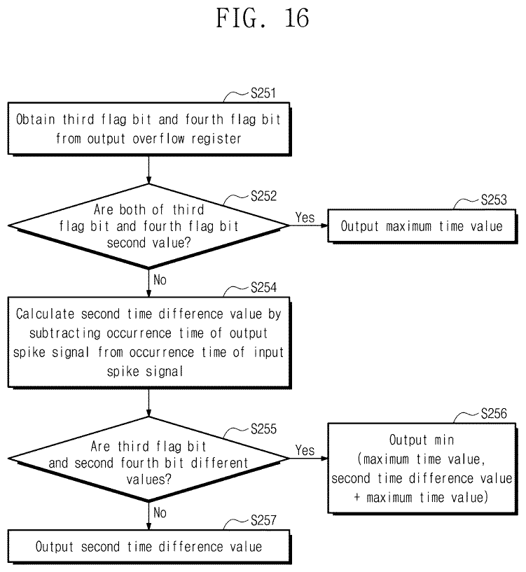

FIG. 16 is a flowchart illustrating a step of calculating the occurrence time difference of the spike signals of FIG. 15.

The step S250 of calculating the occurrence time difference of the spike signals may include a step S251 of obtaining a third flag bit and a fourth flag bit from the output overflow register.

The step S250 of calculating the occurrence time difference of the spike signals may include a step S252 of determining whether both the third flag bit and the fourth flag bit are the second values (e.g., 1).

The step S250 of calculating the occurrence time difference of the spike signals may include a step S253 of outputting the maximum time value when both the third flag bit and the fourth flag bit are the second values (S252—Yes).

The step S250 of calculating the occurrence time difference of the spike signals may include a step 254 of calculating a second time difference value that is a value obtained by subtracting an occurrence time of the output spike signal from the occurrence time of the input spike signal when both the third flag bit and the fourth flag bit are not the second value (S252—No).

The step S250 of calculating the occurrence time difference of the spike signals may include a step S255 of determining whether the third flag bit and the fourth flag bit are different values.

The step S250 of calculating the occurrence time difference of the spike signals may include a step S256 of outputting a smaller value of two quantities: the maximum time value and a sum of the second time difference value and the maximum time value when the third flag bit and the fourth flag bit are different values (S255—Yes).

The step S250 of calculating the occurrence time difference of the spike signals may include a step S257 of outputting the second time difference value when the third flag bit and the fourth flag bit are not different values (S255—No). This condition occurs when both flag bits are the first value (for example, 0).

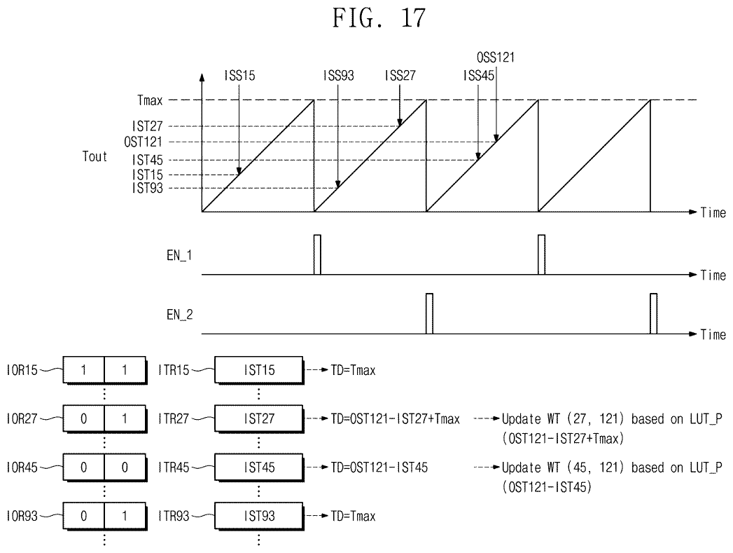

FIG. 17 is a diagram illustrating a weight update for each row line when an output spike signal occurs, according to an embodiment of the present disclosure.

Referring to FIG. 17, the weight value of a portion of the plurality of synapse circuits may be updated according to the occurrence of the output spike signal.

The synapse weight (a, b) refers to the weight value of the synapse circuit corresponding to the row a and the column b. In other words, a charge operation corresponding to the synapse weight (a and b) is performed on a column line of the column b based on an input spike signal of the row a.

Before the occurrence of the output spike signal OSS121, the input spike signals ISS15, ISS93, ISS27, and ISS45 sequentially occurred.

When the input spike signal ISS15 occurs, the occurrence time IST15 of the input spike signal is stored in the input time register ITR15. Both the first flag bit and the second flag bit of the input overflow register IOR15 are initialized to 0. The first flag bit of the IOR15 is toggled from 0 to 1 by the first enable signal EN_1. The second flag bit is toggled from 0 to 1 by the second enable signal EN_2.

When the input spike signal ISS93 occurs, the occurrence time IST93 of the input spike signal is stored in the input time register ITR93. Both the first flag bit and the second flag bit of the input overflow register IOR93 are initialized to 0. The second flag bit of an input overflow register 10R93 is toggled from 0 to 1 by the second enable signal EN_2.

When the input spike signal ISS27 occurs, the occurrence time IST27 of the input spike signal is stored in the input time register ITR27. Both the first flag bit and the second flag bit of the input overflow register IOR27 are initialized to 0. The second flag bit of an input overflow register 10R27 is toggled from 0 to 1 by the second enable signal EN_2.

When the input spike signal ISS45 occurs, the occurrence time IST45 of the input spike signal is stored in the input time register ITR45. Both the first flag bit and the second flag bit of the input overflow register IOR45 are initialized to 0.

When the output spike signal OSS121 occurs, the occurrence time difference TD between the output spike signal OSS121 and the input spike signals ISS15, ISS93, ISS27, and ISS45 may be calculated.

Since both the first flag bit and the second flag bit of the input overflow register IOR15 are 1, the occurrence time difference TD corresponding to the 15th row may be determined as the maximum time value Tmax.

Since the first flag bit of the input overflow register IOR27 is 0 and the second flag bit is 1, a smaller value of two quantities may be output: the maximum time value Tmax and a calculated value OST121-IST27+Tmax obtained by subtracting the occurrence time IST27 of the input spike signal from the occurrence time OST121 of the output spike signal and adding the maximum time value Tmax. In this case, since the calculated value OST121-IST27+Tmax is smaller, the occurrence time difference TD may be determined as the calculated value OST121-IST27+Tmax.

Since both the first flag bit and the second flag bit of the input overflow register IOR45 are 0, the occurrence time difference TD corresponding to the 45th row may be determined as a value OST121-IST45 obtained by subtracting the occurrence time IST45 of the input spike signal from the occurrence time OST121 of the output spike signal.

Since the first flag bit of the input overflow register IOR93 is 0 and the second flag bit is 1, a smaller value of two quantities may be output: the maximum time value Tmax and a calculated value OST121-IST93+Tmax ob obtained by subtracting the occurrence time of the input spike signal IST93 from the occurrence time OST121 of the output spike signal and adding the maximum time value Tmax. In this case, since the maximum time value Tmax is smaller, the occurrence time difference TD may be determined as the maximum time value Tmax.

For the 27th row, the weight change amount LUT_P (OST121-IST27+Tmax) may be determined by referring to the first lookup table LUT_P according to the calculated value OST121-IST27+Tmax. The weight value WT (27, 121) of the synapse circuit corresponding to the 27th row and the 121st column may be updated based on the weight change amount LUT_P (OST 121-IST27+Tmax).

For the 45th row, the weight change amount LUT_P (OST121-IST45) may be determined by referring to the first lookup table LUT_P according to a value OST121-IST45 obtained by subtracting the occurrence time IST45 of the input spike signal from the occurrence time OST121 of the output spike signal. The weight value WT (45, 121) of the synapse circuit corresponding to the 45th row and the 121st column may be updated based on the weight change amount LUT_P (OST 121-IST45).

On the other hand, when the occurrence time difference TD is the maximum time value Tmax, it may be determined that the causal relationship between the input spike signal and the output spike signal does not need to be updated.

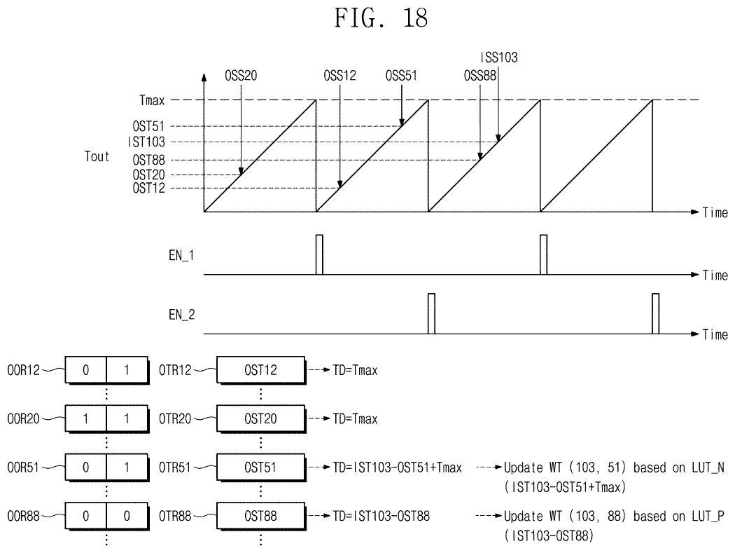

FIG. 18 is a diagram illustrating weight update for each column line when an input spike occurs, according to an embodiment of the present disclosure.

Referring to FIG. 18, before the occurrence of the input spike signal ISS103, the output spike signals OSS20, OSS12, OSS51, and OSS88 sequentially occurred.

When the output spike signal OSS20 occurs, the occurrence time OST20 of the output spike signal is stored in the output time register OTR20. Both the third flag bit and the fourth flag bit of the output overflow register OOR20 are initialized to 0. The third flag bit of the input overflow register OOR20 is toggled from 0 to 1 by the first enable signal EN_1. The fourth flag bit is toggled from 0 to 1 by the second enable signal EN_2.

When the output spike signal OSS12 occurs, the occurrence time OST12 of the output spike signal is stored in the output time register OTR12. Both the third flag bit and the fourth flag bit of the output overflow register OOR12 are initialized to 0. The fourth flag bit of an output overflow register 0OR12 is toggled from 0 to 1 by the second enable signal EN_2.

When the output spike signal OSS51 occurs, the occurrence time OST51 of the output spike signal is stored in the output time register OTR51. Both the third flag bit and the fourth flag bit of the output overflow register OOR51 are initialized to 0. The fourth flag bit of an output overflow register 0OR51 is toggled from 0 to 1 by the second enable signal EN_2.

When the output spike signal OSS88 occurs, the occurrence time OST88 of the output spike signal is stored in the output time register OTR88. Both the third flag bit and the fourth flag bit of the output overflow register OOR88 are initialized to 0.

When the input spike signal ISS103 occurs, the occurrence time difference TD between the input spike signal ISS103 and the output spike signals OSS20, OSS12, OSS51, and OSS88 may be calculated.

Since the third flag bit of the output overflow register OOR12 is 0 and the fourth flag bit thereof is 1, a smaller value of two quantities may be output: the maximum time value Tmax and a calculated value IST103-OST12+Tmax obtained by subtracting the occurrence time OST12 of the output spike signal from the occurrence time IST103 of the input spike signal and adding the maximum time value Tmax. In this case, since the maximum time value Tmax is smaller, the occurrence time difference (TD) may be determined as the maximum time value Tmax.

Since both the third flag bit and the fourth flag bit of the output overflow register OOR20 are 1, the occurrence time difference TD corresponding to the 20th column may be determined as the maximum time value Tmax.

Since the third flag bit of the output overflow register OOR51 is 0 and the fourth flag bit is 1, a smaller value of two quantities may be output: the maximum time value Tmax and a calculated value IST103-OST51+Tmax obtained by subtracting the occurrence time OST51 of the output spike signal from the occurrence time IST103 of the input spike signal and adding the maximum time value Tmax. In this case, since the calculated value IST103-OST51+Tmax is smaller, the occurrence time difference TD may be determined as the calculated value IST103-OST51+Tmax.

Since both the third flag bit and the fourth flag bit of the output overflow register OOR88 are 0, the occurrence time difference TD corresponding to the 88th column may be determined as a value IST103-OST88 obtained by subtracting the occurrence time OST88 of the output spike signal from the occurrence time IST103 of the input spike signal.

For the 51st column, the weight change amount LUT_N (IST103-OST51+Tmax) may be determined by referring to the second lookup table LUT_N according to the calculated value IST103-OST51+Tmax. The weight value WT (103, 51) of the synapse circuit corresponding to the 103rd row and the 51st column may be updated based on the weight change amount LUT_N (IST103-OST51+Tmax).

For the 88th column, the weight change amount LUT_N (IST103-OST88) may be determined by referring to the second lookup table LUT_N according to a value IST103-OST88 obtained by subtracting the occurrence time OST88 of the output spike signal from the occurrence time IST103 of the input spike signal. The weight value WT (WT103, 88) of the synapse circuit corresponding to the 103rd row and the 88th column may be updated based on the weight change amount LUT_N (ST103-OST 88).

On the other hand, when the occurrence time difference TD is the maximum time value Tmax, it may be determined that the causal relationship between the input spike signal and the output spike signal does not need to be updated.

The spike neural network circuit according to an embodiment of the present disclosure may perform STDP learning autonomously through the STDP learning circuit.

What has been described above are specific embodiments for implementing the present disclosure. The present disclosure will include not only the above-described embodiments, but also embodiments that can be simply changed in design or easily changed. In addition, the present disclosure will include technologies that can be easily modified and implemented by using the embodiments. Therefore, the scope of the present disclosure should not be limited to the above-described embodiment, but should be defined by the following claims as well as equivalent to the claims of the present disclosure.

What is claimed is:

1. A spike neural network circuit comprising:
a synapse array including a plurality of row lines, a plurality of column lines, and a plurality of synapse circuits connected to the plurality of row lines and the plurality of column lines and configured to perform a charge accumulation operation on a corresponding column line based on a weight value in response to an input spike signal received through the corresponding row line;
a neuron array including a plurality of neuron circuits configured to generate an output spike signal based on a result of the charge accumulation operation and a threshold potential, wherein the plurality of neuron circuits are connected to one end of the plurality of column lines;
a timer configured to output a time value that increases over time;
an input register array corresponding to each of the plurality of row lines and including a plurality of input time registers configured to store the time value that the timer outputs when the input spike signal occurs on the corresponding row line;
an output register array corresponding to each of the plurality of column lines and including a plurality of output time registers configured to store the time value that the timer outputs when the output spike signal occurs on the corresponding column line;
a time difference calculator configured to calculate an occurrence time difference between occurrence of the output spike signal and occurrence of the input spike signal; and
a weight update circuit configured to update, in response to one of the input spike signal or the output spike signal, the weight value of the plurality of synapse circuits based on a weight change amount corresponding to the occurrence time difference.

2. The spike neural network circuit of claim 1,
wherein the input register array further includes a plurality of input overflow registers corresponding to each of the plurality of row lines, and
wherein the output register array further includes a plurality of output overflow registers corresponding to each of the plurality of column lines.

3. The spike neural network circuit of claim 2,
wherein the timer is further configured to initialize the time value in response to the time value reaching a maximum time value, and to repeatedly performs outputting the increasing time value and initializing the time value.

4. The spike neural network circuit of claim 3,
wherein the timer is further configured to alternately output one of a first enable signal or a second enable signal in response to initialization of the time value.

5. The spike neural network circuit of claim 4, wherein:
each of the plurality of input overflow registers includes a first flag bit and a second flag bit,
each of the plurality of output overflow registers includes a third flag bit and a fourth flag bit,
the first flag bit and the third flag bit are toggled from a first value to a second value in response to the first enable signal, and
wherein the second flag bit and the fourth flag bit are toggled from the first value to the second value in response to the second enable signal.

6. The spike neural network circuit of claim 5, wherein:
each of the first flag bit and the second flag bit included in each of the plurality of input overflow registers is initialized to the first value in response to the corresponding input spike signal of the corresponding row line; and
each of the third flag bit and the fourth flag bit included in each of the plurality of input overflow registers is initialized to the first value in response to the corresponding output spike signal of the corresponding column line.

7. The spike neural network circuit of claim 6,
wherein in response to occurrence of the output spike signal, the time difference calculator is further configured to, for each of the plurality of row lines:
output the maximum time value when both the first flag bit and the second flag bit are the second value;
output a smaller value between the maximum time value and a value obtained by adding a first time difference value to the maximum time value when the first flag bit and the second flag bit are different values;
output the first time difference value when both the first flag bit and the second flag bit are the first value; and
wherein the first time difference value is obtained by subtracting a time value stored in the input register corresponding to each of the plurality of row lines from the time value when the output spike signal occurred.

8. The spike neural network circuit of claim 6,
wherein in response to occurrence of the input spike signal, the time difference calculator is further configured to, for each of the plurality of column lines:
output the maximum time value when both the third flag bit and the fourth flag bit are the second value;
output a smaller value between the maximum time value and a value obtained by adding a second time difference value to the maximum time value when the third flag bit and the fourth flag bit are different values;
output the second time difference value when both the third flag bit and the fourth flag bit are the first value; and
wherein the second time difference value is obtained by subtracting a time value stored in the output register corresponding to each of the plurality of column lines from the time value when the input spike signal occurred.

9. The spike neural network circuit of claim 1,
wherein each of the plurality of synapse circuits includes:
a weight memory configured to store the weight value; and
a digital-to-analog converter configured to supply a charge corresponding to the weight value to the corresponding column line in response to the input spike signal.

10. The spike neural network circuit of claim 9,
wherein the weight update circuit comprises:
a weight change memory configured to store the weight change amount according to an occurrence time difference; and
a weight calculator configured to determine a target weight change amount with reference to the occurrence time difference and the weight change memory for a target synapse circuit of the plurality of synapse circuits and update a weight value of the target synapse circuit based on the target weight change amount.

11. The spike neural network circuit of claim 10,
wherein the weight change memory includes:
a first lookup table configured to store the weight change amount according to a causal type; and
a second lookup table configured to store the weight change amount according to the non-causal type.

12. A spike-timing dependent plasticity (STDP) learning circuit comprising:
a timer configured to output a time value that increases over time;
a plurality of input time registers corresponding to each of a plurality of row lines of a synapse array and configured to store the time value that the timer outputs when an input spike signal occurs on the corresponding row line;
a plurality of output time registers corresponding to each of a plurality of column lines of the synapse array and configured to store the time value that the timer outputs when an output spike signal occurs on the corresponding column line;
a time difference calculator configured to calculate an occurrence time difference between occurrence of the output spike signal and occurrence of the input spike signal;
a weight update circuit configured to update, in response to occurrence of the input spike signal or occurrence of the output spike signal, a weight value of the corresponding synapse circuits included in the synapse array based on a weight change amount corresponding to the occurrence time difference; and
a control circuit configured to control operation of the timer, the plurality of input time registers, the plurality of output time registers, the time difference calculator, and the weight update circuit.

13. The STDP learning circuit of claim 12,
wherein the timer is further configured to:
initialize the time value in response to the time value reaching a maximum time value;
repeatedly output the increasing time value and initialize the time value; and
alternately output one of a first enable signal or a second enable signal in response to the initialization of the time value.

14. The STDP learning circuit of claim 13, further comprising:
a plurality of input overflow registers corresponding to each of the plurality of row lines and including a first flag bit and a second flag bit,
wherein the first flag bit is initialized to a first value in response to the corresponding input spike signal, and toggled from the first value to a second value in response to the first enable signal, and
wherein the second flag bit is initialized to the first value in response to the corresponding input spike signal and toggled from the first value to the second value in response to the second enable signal.

15. The STDP learning circuit of claim 14, further comprising:
a plurality of output overflow registers corresponding to each of the plurality of column lines and including a third flag bit and a fourth flag bit,
wherein the third flag bit is initialized to the first value in response to the corresponding output spike signal, and toggled from the first value to the second value in response to the first enable signal, and
wherein the fourth flag bit is initialized to the first value in response to the corresponding output spike signal and toggled from the first value to the second value in response to the second enable signal.

16. The STDP learning circuit of claim 15,
wherein the time difference calculator is further configured to:
output the maximum time value for rows in which both the first flag bit and the second flag bit are the second value;
output, for rows in which the first flag bit and the second flag bit are different values, a smaller value between the maximum time value and a value obtained by adding the maximum time value to a value obtained by subtracting an occurrence time of the input spike signal from an occurrence time of the output spike signal; and
output, for rows in which both the first flag bit and the second flag bit are the first value, the value obtained by subtracting the occurrence time of the input spike signal from the occurrence time of the output spike signal.

17. The STDP learning circuit of claim 16,
wherein the time difference calculator is further configured to:
output the maximum time value for columns in which both the third flag bit and the fourth flag bit are the second value;
output, for columns in which the third flag bit and the fourth flag bit are different values, a smaller value between the maximum time value and a value obtained by adding the maximum time value to a value obtained by subtracting the occurrence time of the output spike signal from the occurrence time of the input spike signal; and
output, for columns in which both the third flag bit and the fourth flag bit are the first value, the value obtained by subtracting the occurrence time of the output spike signal from the occurrence time of the input spike signal.

18. The STDP learning circuit of claim 16,
wherein the weight update circuit comprises a first lookup table configured to store a weight change amount corresponding to a causal type and a second lookup table configured to store a weight change amount corresponding to a non-causal type.

19. An operation method of a spike-timing dependent plasticity (STDP) learning circuit, the operation method comprising:
receiving an output spike signal from one of a plurality of columns;
writing an occurrence time of the output spike signal into an output time register corresponding to a column line in which the output spike signal occurred;
initializing an output overflow register corresponding to the output spike signal;
obtaining an occurrence time of an input spike signal written in an input time register for each of a plurality of row lines;
calculating an occurrence time difference between the occurrence time of the output spike signal and the occurrence time of the input spike signal for each of the plurality of row lines;
obtaining a weight change amount according to the time difference for each of the plurality of row lines;
obtaining a weight value for each of the synapse circuits corresponding to the column line in which the output spike signal occurred; and
updating the weight value of each of the corresponding synapse circuits in the column line in which the output spike signal occurred by applying the weight change amount to each of the corresponding synapse circuits.

20. The operation method of claim 19, further comprising:
receiving an input spike signal from one of a plurality of rows;
writing an occurrence time of the input spike signal into an input time register corresponding to a row line in which the input spike signal occurred;
initializing an input overflow register corresponding to the input spike signal;
obtaining an occurrence time of an output spike signal written in an output time register for each of a plurality of column lines;
calculating an occurrence time difference between the occurrence time of the input spike signal and the occurrence time of the output spike signal for each of the plurality of column lines;
obtaining a weight change amount according to the time difference for each of the plurality of column lines;
obtaining a weight value for each of the synapse circuits corresponding to the row line in which the input spike signal occurred; and
updating the weight value of each of the corresponding synapse circuits in the row line in which the input spike signal occurred by applying the weight change amount to each of the corresponding synapse circuits.
